(19) United States
(12) Patent Application Publication
(10) Pub. No.: US 2015/0007269 A1
(43) Pub. Date: Jan. 1, 2015

(54) DELEGATING AUTHENTICATION FOR A WEB SERVICE

(71) Applicant: International Business Machines Corporation, Armonk, NY (US)

(72) Inventors: Dominik W. Brugger, Kassel (DE); Matthias Seul, Kassel (DE)

(21) Appl. No.: 13/928,450

(22) Filed: Jun. 27, 2013

(51) Int. Cl. H04L 29/06

(52) U.S. Cl. CPC H04L 63/0884
USPC 726/4

(57) ABSTRACT

Embodiments include a method for delegating authentication for a web service to a delegatee. The delegation includes a request being detected at a delegation service from a web service for a first credential of a delegator. The first credential has authorization to access the web service. A request is detected from a delegatee having a second credential, at the delegation service, to use the web service with the first credential. The delegation service determines whether the second credential authorizes the delegatee to use the web service with the first credential. The delegation service authorizes access to the web service for use by the second credential of the delegatee with the first credential.

### FIELD

This disclosure generally relates to web service access control, and in particular, to delegation of authentication for a web service.

### BACKGROUND

Software services implemented in web-based interfaces instead of traditional executable drive software or traditional client-server models deployed at the customer site are on the rise. Collaboration tools such as email, document sharing, or file storage may be affected by this change. All of these services require some degree of authentication/authorization to either work with them at all or gain access to all (or a restricted set of) features. Authentication is usually handled on a username-pas sword basis with each user having a separate account. These accounts are sometimes synchronized with a corporate directory service (such as lightweight directory access protocol (LDAP)) to enable single-sign-on across services.

### SUMMARY

Embodiments of the disclosure provide a method, a computer system, and a computer readable medium for delegating authentication for a web service to a delegatee. The delegation includes a request being detected at a delegation service from a web service for a first credential of a delegator. The first credential has authorization to access the web service. A request is detected from a delegatee having a second credential, at the delegation service, to use the web service with the first credential. The delegation service determines whether the second credential authorizes the delegatee to use the web service with the first credential. The delegation service authorizes access to the web service for use by the second credential of the delegatee with the first credential.

### BRIEF DESCRIPTION OF THE DRAWINGS

FIG. 1 illustrates a computing infrastructure configured to execute a delegation service for a web service, according to various embodiments.

FIG. 2 illustrates a more detailed view of a client computer system of FIG. 1 including a browser, according to various embodiments.

FIG. 3 illustrates a more detailed view of a network node of FIG. 1 including the delegation service, according to various embodiments.

FIG. 4 illustrates a more detailed view of the server computer system of FIG. 1 including a web service, according to various embodiments.

FIG. 5 illustrates a more detailed block diagram of various modules of the delegation service, according to various embodiments.

FIG. 6 illustrates a delegation ticket of the delegation service, according to various embodiment.

FIG. 7 illustrates an exemplary delegation service interface injection on a web page of a web service, according to various embodiments.

FIG. 8 illustrates a flow chart of a work flow of the delegation service, according to various embodiments.

FIG. 9 illustrates a high level flow chart of a method of performing web service delegation, according to an embodiment.

Like reference numbers and designations in the various drawings indicate like elements.

### DETAILED DESCRIPTION

Web-based services are becoming more and more ubiquitous across all organizations. Common examples of this technology are web-based email offerings, social networks, sales lifecycle, and other software products deployed as web services instead of traditional executable driven software. These web services require some sort of authentication/authorization for a user to work with them and have access to some or all of the features the web services offer. Authentication may be handled by a username and password with each user having separate accounts. The management of access may be simplified by widespread use of directory-based authentication (e.g. LDAP) or single-sign-on products (Tivoli Single-Sign-On, Tivoli Identity Manager).

In organizations, for example, some members of the organization may have access to these web services while others may not. However, in some instances, it may be necessary for a member that does not have access to a particular web service to gain full or partial access to the web service temporarily. For instance, in a manager-assistant level, for colleagues working in the same division, and for backups during out-of-office scenarios, it may be necessary to allow others, not having credentials of a web service, access to the web service. Even though many web services are geared towards organizations with multiple members, many web services do not offer delegation. Having no delegation of credentials may lead to either customers avoiding usage of the web service, or if there is no alternative to the web service, falling back to account and password sharing. This may lead to a variety of security issues and misuse. For instance, a delegatee (a user of a web service using an authorized user's (delegator's) credentials to access the web service) could easily perform unwanted actions or steal the login data for malicious usage outside the network of the corporation.

Embodiments herein provide for a delegation service that may allow a delegatee to access a web service using credentials of a delegator. The delegation service may be transparent to both the delegatee and the web service. The delegation service may work independent of any web service. The delegation service may be configured to allow delegation without the delegatee obtaining the credentials of the delegator. Furthermore, the delegation service may be used to restrict access of the delegatee to certain features of the web service. In other embodiments, the delegation service may provide security features to protect a delegatee's session on the web service and the delegator's credentials. The delegation service may also allow concurrent usage of the web service under the same credentials.

Generally, embodiments herein may provide for a delegation service that allows a delegator to create a delegation for a web service the delegator has authorization credentials. The delegation may be created for a delegatee to use the web service. The delegation may have limitations on the scope of use of the web service by the delegatee. The delegatee may not have authorization credentials to the web service but may have credentials for the delegation service. The delegatee may ask the delegation service for access to the web service. The delegation service may determine whether the delegatee has access to the web service. If the delegatee does, then the delegation service may use the credentials of the delegator to access the web service. The data may be hidden or encrypted to protect the delegation session and the credentials of the delegator. Furthermore, the delegation service may monitor the delegatee's actions on the web service to ensure they are appropriate.

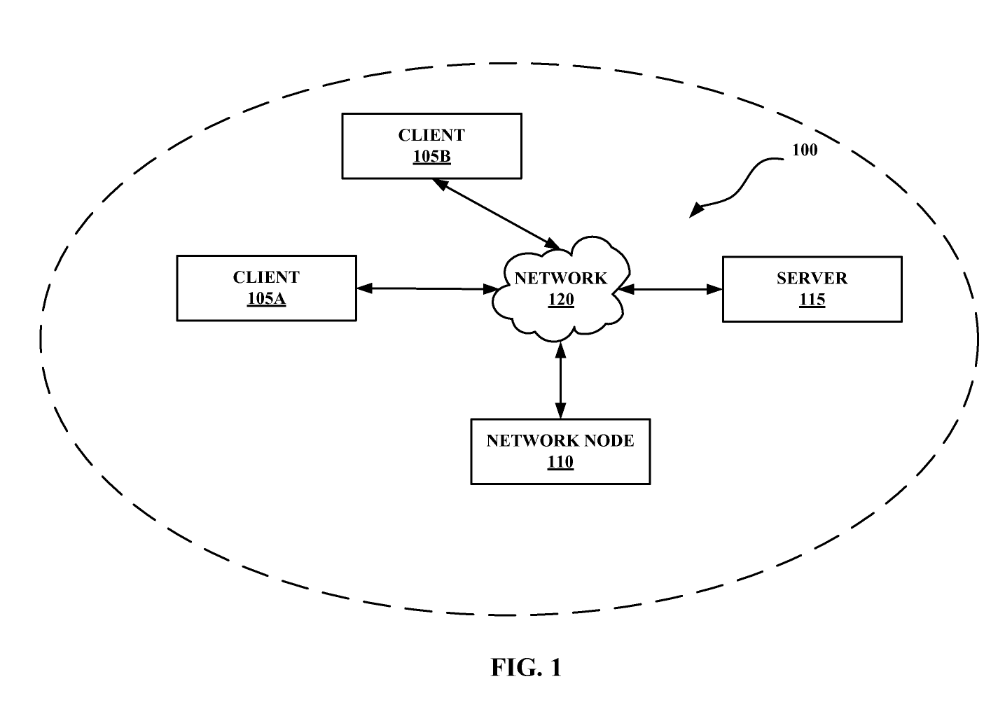

FIG. 1 illustrates one exemplary computing infrastructure 100 that may be configured to execute a delegation service, according to some embodiments. The computing infrastructure 100 may include one or more client computing systems such as a first client computer system 105A and a second client computer system 105B. The computing infrastructure 100 may also include a network node 110, and a server computer system 115, which are communicatively coupled to each other using one or more communications networks 120, also referred to herein as network 120. The communications network 120 may include one or more servers, networks, databases, or gateways such as HTTP/HTTPs, and may use a particular communication protocol to transfer data between the computer systems 105, 110, 115. In one embodiment, the network node 110 and its functions may be part of the network 120.

The communications network 120 may include a variety of types of physical communication channels or “links.” The links may be wired, wireless, optical, or any other suitable media. In addition, the communications network 120 may include a variety of network hardware and software for performing routing, switching, and other functions, such as routers, switches, or bridges. The communications network 120 may be any size. For example, the communications network 120 may include a single local area network or a wide area network of networks spanning a large geographical area, such as the Internet.

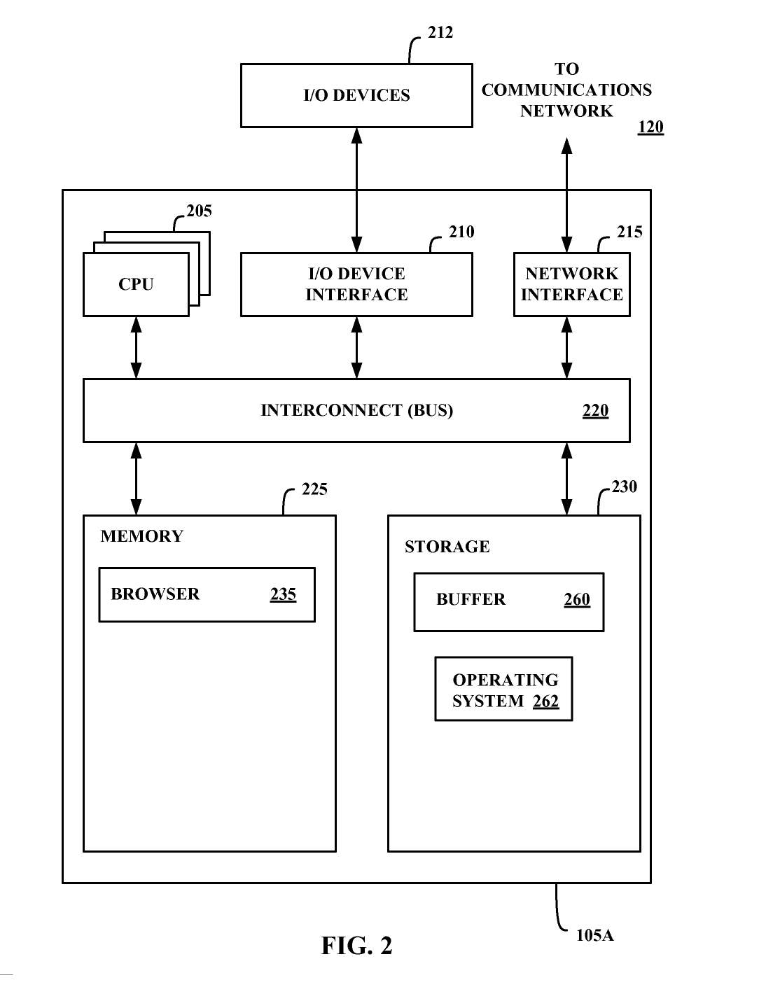

FIG. 2 is a more detailed view of the first client computer system 105A of FIG. 1, according to various embodiments. The first client computer systems 105A may be representative of the second client computer system 105B as well. The first and second client computer systems 105A and 105B may be referred to generally as client computer system 105 herein. Also, any of the client computer systems may be referred to simply as client 105 herein.

The client computer system 105 may include, without limitation, one or more processors (CPUs) 205, a network interface 215, an interconnect 220, a memory 225, and a storage 230. The client computer system 105 may also include an I/O device interface 210 used to connect I/O devices 212, e.g., keyboard, display, and mouse devices, to the client computer system 105.

Each CPU 205 retrieves and executes programming instructions stored in the memory 225 or storage 230. Similarly, the CPU 205 stores and retrieves application data residing in the memory 225. The interconnect 220 is used to transmit programming instructions and application data between each CPU 205, I/O device interface 210, storage 230, network interface 215, and memory 225. The interconnect 220 may be one or more busses. The CPUs 205 may be a single CPU, multiple CPUs, or a single CPU having multiple processing cores in various embodiments. In an embodiment, a processor 205 may be a digital signal processor (DSP). One or more browsers 235 (described further below) may be stored in the memory 225. In an embodiment, a browser 235 is assigned to be executed by a CPU 205. The memory 225 is generally included to be representative of a random access memory, e.g., Static Random Access Memory (SRAM), Dynamic Random Access Memory (DRAM), or Flash. The storage 230 is generally included to be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 215 is configured to transmit data via the communications network 120.

The browser 235 is a software application that enables a user to display and interact with text, images, and other information typically located on a web page of a web service at a website on the Internet or a local area network. Text and images on a web page can contain hyperlinks to other web pages at the same or different website. The browser 235 may allow a user to quickly and easily access information provided on many web pages at many websites by traversing these links. The browsers may format HTML information for display, so the appearance of a web page may differ between browsers. The browsers 235 may communicate with web servers also referred to as server computer system 115 primarily using HTTP (hypertext transfer protocol) to retrieve web pages over the communication network 120. Server computer system 115 includes a computer program that is responsible for accepting HTTP requests from client computer systems 105, and serving them HTTP responses along with optional data contents, which usually are web pages such as HTML documents and linked objects (images, etc.).

The storage 230 may include a buffer 260. Although shown as being in storage, the buffer 260 may be located in the memory 225 of the compute node 110 or in a combination of both memories. Moreover, storage 230 may include storage space that is external to the compute node 110, such as in a “cloud.”

The client 105 may include one or more operating systems 262. An operating system 262 may be stored partially in memory 225 and partially in storage 230. Alternatively, an operating system 262 may be stored entirely in memory 225 or entirely in storage 230. The operating system 262 provides an interface between various hardware resources, including the CPU 205, and processing elements and other components of the stream computing application. In addition, an operating system 2626 may provide common services for application programs, such as providing a time function.

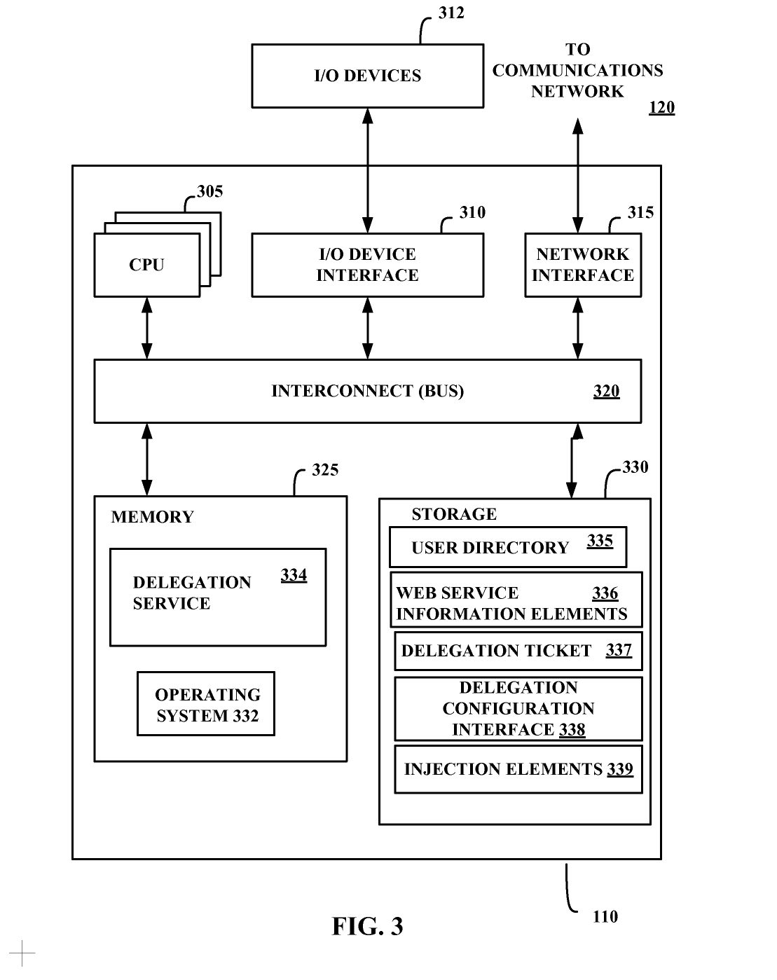

FIG. 3 is a more detailed view of the network node 110 of FIG. 1, according to some embodiments. The network node 110 may include, without limitation, one or more processors (CPUs) 305, a network interface 315, an interconnect 320, a memory 325, and a storage 330. The network node 110 may also include an I/O device interface 310 connecting I/O devices 312, e.g., keyboard, display, and mouse devices, to the network node 110.

Each CPU 305 retrieves and executes programming instructions stored in the memory 325 or storage 330. Similarly, each CPU 305 stores and retrieves application data residing in the memory 325 or storage 330. The interconnect 320 is used to move data, such as programming instructions and application data, between the CPU 305, I/O device interface 310, storage 330, network interface 315, and memory 325. The interconnect 320 may be one or more busses. The CPUs 305 may be a single CPU, multiple CPUs, or a single CPU having multiple processing cores in various embodiments. In an embodiment, a processor 305 may be a DSP. Memory 325 is generally included to be representative of a random access memory, e.g., SRAM, DRAM, or Flash. The storage 330 is generally included to be representative of a non-volatile memory, such as a hard disk drive, solid state device (SSD), removable memory cards, optical storage, Flash memory devices, network attached storage (NAS), connections to storage area-network (SAN) devices, or the cloud. The network interface 315 is configured to transmit data via the communications network 120.

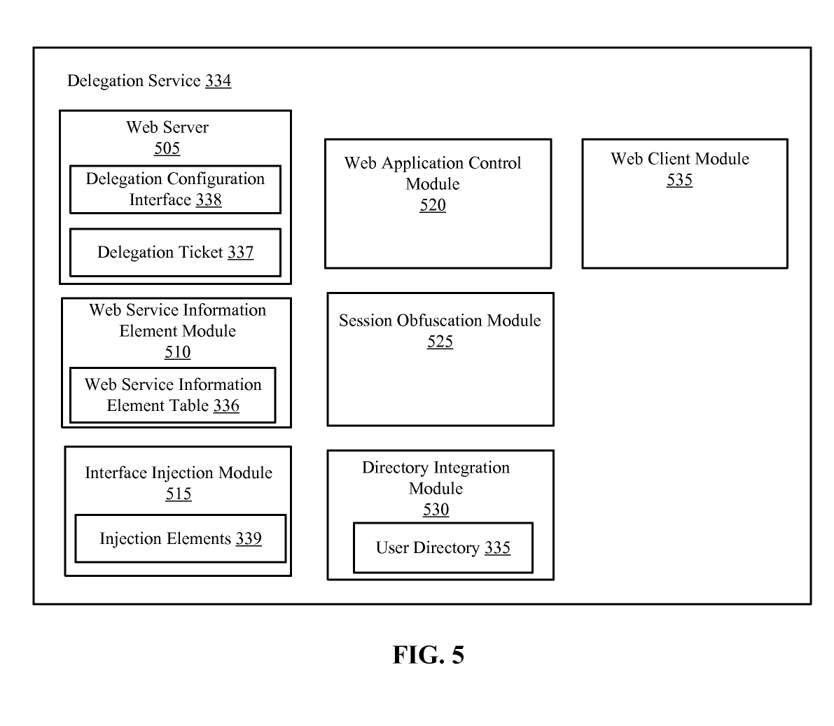

The memory 325 may store a delegation service 334, which is further described below in FIG. 5. Additionally, the memory 325 or storage 330 may store a user directory 335, a web service information element 336, a delegation ticket 337, delegation configuration interface 338, injection elements 339, and encryption keys (all described further below).

The network node 110 may include one or more operating systems 332. An operating system 332 may be stored partially in memory 325 and partially in storage 330. Alternatively, an operating system may be stored entirely in memory 325 or entirely in storage 330. The operating system provides an interface between various hardware resources, including the CPU 305, and processing elements and other components of the stream computing application. In addition, an operating system provides common services for application programs, such as providing a time function.

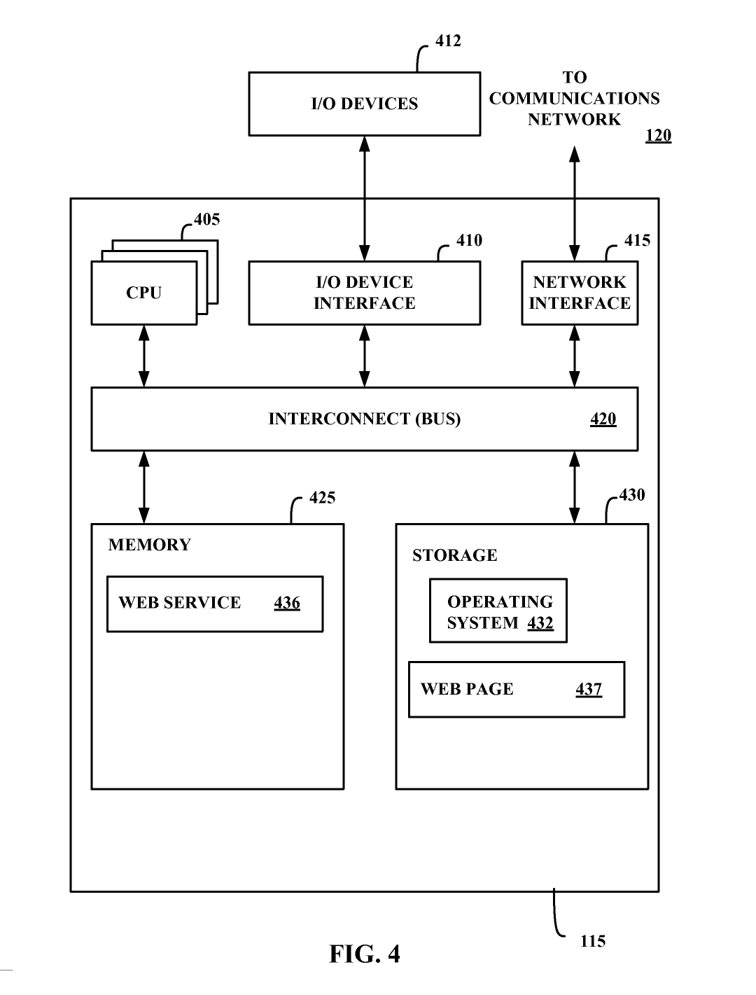

The network node 110 may be a web gateway, such as an HTTP/HTTPS gateway or proxy server or any other access point in a data stream across the communications network 120 between the client 105 and a web service 436 (FIG. 4) targeted such as the web service 436 on the server computer system 115.

FIG. 4 is a more detailed view of the server computer system 115 of FIG. 1, according to various embodiments. The server computer system 115 may include, without limitation, one or more processors (CPUs) 405, a network interface 415, an interconnect 420, a memory 425, and storage 430. The server computer system 115 may also include an I/O device interface 410 connecting I/O devices 412, e.g., keyboard, display, and mouse devices, to the computer system 115.

Each CPU 405 retrieves and executes programming instructions stored in the memory 425 or storage 430. Similarly, each CPU 405 stores and retrieves application data residing in the memory 425 or storage 430. The interconnect 420 is used to move data, such as programming instructions and application data, between the CPU 405, I/O device interface 410, storage unit 430, network interface 415, and memory 425. The interconnect 420 may be one or more busses. The CPUs 405 may be a single CPU, multiple CPUs, or a single CPU having multiple processing cores in various embodiments. In an embodiment, a processor 405 may be a DSP. Memory 425 is generally included to be representative of a random access memory, e.g., SRAM, DRAM, or Flash. The storage 430 is generally included to be representative of a non-volatile memory, such as a hard disk drive, solid state device (SSD), removable memory cards, optical storage, flash memory devices, network attached storage (NAS), connections to storage area-network (SAN) devices, or to the cloud. The network interface 415 is configured to transmit data via the communications network 120.

The server computer system 115 may include one or more operating systems 432 and one or more web pages 437. An operating system 432 and a web page 437 may be stored partially in memory 425 and partially in storage 430. Alternatively, an operating system 432 and a web page 437 may be stored entirely in memory 425 or entirely in storage 430. The operating system 432 provides an interface between various hardware resources, including the CPU 405, and processing elements and other components of the stream computing application. In addition, an operating system 432 provides common services for application programs, such as providing a time function.

The memory 425 may store a web service 436. The web service 436 may be any type of web service such as email, social media, banking, and subscription services, for example, that requires a user account. The web service 436 may include web page(s) 437 which is a resource of information that is suitable for the Internet and can be accessed through a web browser 235. This information is usually in HTML or XHTML format, and may provide navigation to other web pages via hypertext links. Web page 437 may be retrieved from a local computer or from a remote web server such as the server computer system 115. The server computer system 115 may restrict access only to a private network, e.g., a corporate intranet, or it may publish pages on the Internet. Web pages 437 of the web service 436 may be requested and served from server computer system 115 using Hypertext Transfer Protocol (HTTP). A web page 437 may be a type of web document. Web page 437 may consist of files of static text stored within the server computer system's 115 file system (static web pages), or the server computer system 115 may construct the (X)HTML for each web page 437 when it is requested by a browser 235 (dynamic web pages). A client computer system 105 may access the web service 436 over the communications network 120. Client-side scripting can make web pages 436 more responsive to user input once in the client browser 235. In an embodiment, one or more of the applications and data described in the various memories and storage of devices of FIG. 2, FIG. 3, and FIG. 4 may be in one of the device or a combination of devices.

FIG. 5 illustrates the delegation service 334 in more detail, according to an embodiment. The delegation service 334, as discussed in FIG. 3, may be in the stream of communications between the browser 235 on the client computer system 105 and the web service 436 on a server computer system 115. In certain embodiments, the delegation service 334 may be part of a gateway or proxy server. The delegation service 334 may have sub-modules that perform the function of the delegation service. These modules may include a web server 505, a web service information element module 510, and interface injection module 515, a web application control module 520, a session obfuscation module 525, directory integration module 530, and a web client module 535.

Generally, the delegation service 334 may allow for delegation of a delegator's credentials to the web service 436 to a delegatee. The delegator may selectively allow access of the features of the web service 436 to the delegatee without the delegatee obtaining specific knowledge of the delegator's credentials when accessing the web service 436. Furthermore, the delegation service 334 may work with any web service 436 and does not need to be incorporated into the web service 436. The web service 436 may be unaware that a delegation has occurred. The delegation service 334 may receive request/response information from the network node 110 and coordinates with the other components doing the actual delegation handling. The communication between the network node 110 and the delegation service 334 may be done using standard protocols such as ICAP or eCAP.

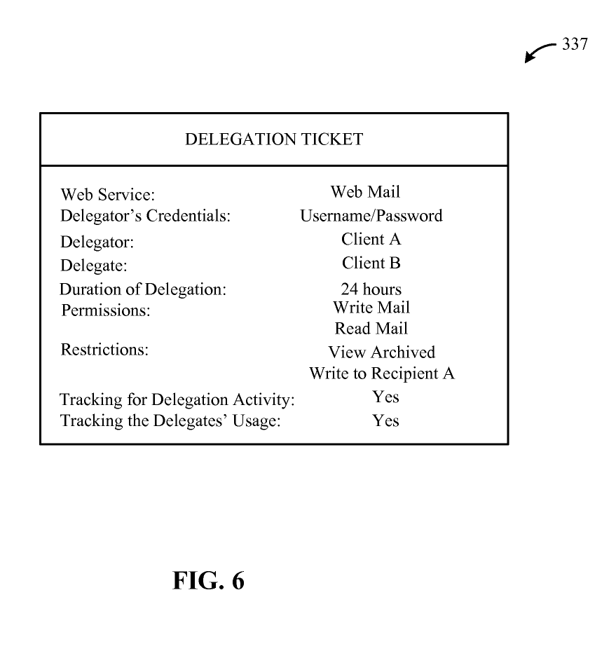

In an embodiment, the web server 505 may be part of the delegation service 334. The web server 505 may provide delegation configuration interfaces 338 to client computer systems 105A and 105B. The delegation configuration interfaces 338 may be general graphical configuration interfaces for the client 105 to enter data and perform operations. For instance, with the delegation configuration interfaces 338, a delegator may create a delegation ticket 337. The delegation ticket 337, further described in FIG. 6, may include the web service 436 to be delegated and who the delegatee is. For instance, the delegation ticket 337 may give the credentials of the delegator, state the delegatee, give a time duration the delegatee can use the delegator's credentials, the web service or services the delegatee is allowed access to under the delegator's credentials, and what restrictions and permissions the delegatee has with regards to the features of the web service 436.

In an embodiment, the delegation service 334 may include the web service information element module 510. Generally, the web service information element module 510 may determine the specific actions that may be taken on the web service 436 by gathering information about the web service 436. The web service information element module 510 may create information element table 336, which may be stored in memory or storage as discussed in FIG. 3. The information element table 336 may include information elements about the web service 436 such as the name of the web service 436, description, URLs, and IP addresses under which the web service 436 is hosted. The information element table 336 may also list supported actions that can be taken with the web service 436.

Some actions that may be of particular importance to the delegation service 334 are the “Login” and “Logout” actions as well as “Success” and “Failure” states of such actions since they are most relevant with delegation. However, other actions of the delegation service 334 may be detected. These actions may include actions that can be taken with the web service 436 and may be part of a list of options that a delegator can select from to give permissions and restrictions to the delegatee. For instance, in the example of email, there may be actions available such as save, draft, archive, send, open, and delete to name a few. The web service information element module 510 may detect the actions and include them in the information element table 336. These actions may be presented to a delegator when interacting with the delegation configuration interface 338 when setting up restrictions and permissions for the delegatee.

In an embodiment, to detect whether a specific action of the web service 436 may be taken, several criteria may be defined. These include but are not limited to:
The specific/pattern of the URL accessed by a client
Presence or absence of page elements
Presence or absence of text on the page
Presence, absence, and contents of cookies and page parameters
Any of the above combinations
   Each of the criteria may be configured separately for each page and web service 436 and weighted with a (positive, negative, or neutral) score for the presence or absence with the web service information element module 510. A criteria may also be defined as required or optional. Additionally, a score limit may be defined to determine whether an action exists or not on a web service 436 when evaluating the score limit with the criteria. This could be done by checking whether all required criteria are met, summing up the scores of all criteria and checking whether the total sum meets a threshold score limit. If met, the delegation service 334 may determine the action to be “available” on the current web service 436.

The weighting and scoring takes into account the volatile nature of the web service 436 with web pages 437 changing in contents frequently, allowing action definitions to work for a long time without maintenance even if the targeted web page 437 structure has changed.

In addition to detecting whether an action is available, the web service information element module 510 may store steps with the action that describe to the delegation service 334 what steps to take to trigger the action. This may be a sequence of actions such as input of data into specific page elements, certain pauses in execution, and page clicks. These embodiments, may allow the delegation service 334 to emulate the behavior of the delegator and allow the delegation service 334 to react to specific conditions such as “Login”, “Proceed with Login”, and “Check Login Completed?”, for example.

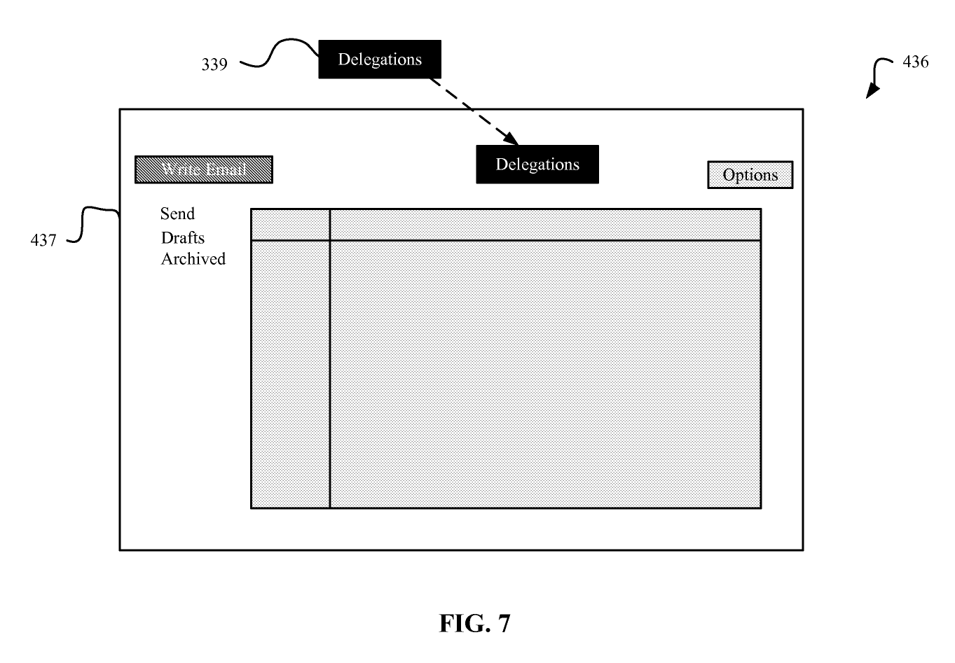

In another embodiment, the delegation service 334 may include the interface injection module 515. The interface injection module 515 may allow for integration of the delegation service 334 with the web service 436. The interface injection module 515 may incorporate injection elements 339, which are user interface features of the delegation service 334, with the user interface of the web service 436. For example, the injection module 515 may allow the delegation service 334 to add interface elements 339 “Create Delegation” or “Use Delegation” access buttons to a given user interface of a web service 436 (See FIG. 7 for an example).

The interface injection may be completed by the interface injection module 515 examining the data stream between the web service 436 and the browser 235 of the client computer system 105. The interface injection module 515 may check whether a specific page is being transferred that the interface elements 339 are determined to be incorporated with, e.g. the main overview page. If the specific page is located, then the interface injection module 515 may modify the transferred page's HTML source code with the code for the interface elements 339 before delivering the specific page to the client computer system 105. In an embodiment, the interface injection may be direct modifications of the HTML code or the injection may be of active Javascript code that does on-the-fly document object model (DOM) tree edits. The interface injection module 515 may allow the client 105 to access delegation specific setup and management options without having to leave the web service 436.

In another embodiment, the delegation service 334 may include a web application control module 520. The web application control module 520 may filter the web service 436 to understand the specific actions available on the web service 436, such as “Chat”, “Upload”, and “Start Application”, for example. The web application control module 520 may be able examine a given request/response by the client 105 and return both the application accessed and action taken. The web application module 520 may compare the restrictions and permissions of the delegation element ticket 337 with the application or action information and react if necessary by blocking or granting the request or response, for example. In another embodiment, the web application control module 520 may also have the capability to scan accessed documents and downloads for specific patterns (even over multiple levels of compression or embedding) and react if restructured content is located, e.g. by denying access to the file or signaling IT security staff. In an example, the web application control module 520 may be a computer program such as IBM Security Content Analysis Software Development Kit.

In another embodiment, the delegation service 334 may include a session obfuscation module 525. The session obfuscation module 525 may be used to protect a delegation session from being replayed or hijacked to prevent unintended users from extracting a valid running delegation session from the environment of the organization and running it in an uncontrolled network. Security of the delegation session may be at risk since parts of the delegation session's restrictions are realized via the web application control module 520 which may be done on the network node 110. If an unintended user is able to take the session and run it outside the network controlled by the network node 110, then the restrictions to the delegation would no longer apply, which may be undesirable. Since the client computer system 105 does not need to know the actual session identifiers, such as session cookies or IDs a web service 436 uses to identify a user's session, it is therefore feasible to encrypt all the delegator's relevant information before sending the delegator's information to the client computer system 105. Other data obfuscation methods may be used to hide the delegator's information from the client computer system 105 besides encryption such as, but not limited to, substitution, shuffling, number variance, deletion, and masking.

Only session-relevant data may be encrypted. The actual page contents of the web service 436 such as text, images, and links are not under risk for session hijacking are left alone. Determining what gets encrypted and what does not may be done by applying both general heuristics and web service specific patterns to detect non-client relevant data (e.g. session Ids, URLs, Cookies). A delegation session encryption key may be created, which may encrypt all found non-client relevant data. The non-client relevant data may be tagged with a special pattern before sending it to the client computer system 105. The encryption used may be any acceptable encryption/decryption procedure. All the encryption/decryption may take place at the delegation service.

In certain embodiments, the encryption key may be generated on a per-session, per-delegation basis to prevent unauthorized users form gaining access to all sessions in case a single key is cracked. The encryption key may be stored on the network node 110 and never given to any delegatees. The delegation session may be discarded as soon as the session the key the delegation session is associated with expires or a given time frame. Data received by the network node 110 from the client computer system 105 may be examined as to whether it contains the special pattern and is then decrypted using the session-specific encryption key before sending it to the server 115.

By obfuscating non-client relevant data the delegatee may never see sensitive session data in usable form and therefore will not be able to take a session out of the protected network. Also, the web service 436 may not know of the session obfuscation since it is performed at the network node 110 with the delegation service 334. In another embodiment, using session obfuscation may allow multiple sessions with different users active for a given web service 436 under the same credentials.

In another embodiment, the delegation service 334 may include a directory integration module 530. The directory integration module 530 may incorporate a user directory 335 into the delegation service 334. The user directory 335 may include all the users who may access the delegation service 334, for example. The user directory may include the credentials of the users or may provide for credentials from specific clients 105. For instance, the delegator may select, from the user directory 335, a delegatee that may use the delegator's credentials when creating a delegation element ticket 337. In an embodiment, the delegation service 334 may not be set up to have the delegator select credentials for the delegatee to access the delegation element ticket 337. Therefore, upon selecting the specific delegatee, the delegation service 334, through the directory integration module 530, may determine whether the client computer system 105, trying to access the web service 436, through the delegation element ticket 337, is the delegatee authorized to do so. In certain embodiments, the directory integration module 530 may check credentials of a delegator trying to access a delegation element ticket 337 to credentials stored in the user directory 335. In other embodiments, the directory integration module 530 may recognize the delegator when the delegator logs on to the organization's secure network such as an LDAP.

In another embodiment, the delegation service 334 may include a web client module 535. The web client module 535 may be a headerless browser module that is used to facilitate the login (or other sensitive) actions before handing over the session to the delegatee. The web client module 535 may also apply to actions taken while the session is already under the delegatee's control such as logging out the delegatee after a time limit of a delegation session is met. The web client module 535 may then run in the background and send requests to the web service 436 as if it was the delegator. The web service 436 should not know that the session being created is actually being delegated to a delegatee from a delegator. This allows for the delegation service 334 to be used with any web service 436.

In other embodiments, the web client module 535 may do validation of a delegatee's identity both by requiring secure communication (e.g. SSL/TLS or similar method of encryption) and doing certificate validation. The web client module 535 may also scan the received code of web pages 437 of the web service 436 for malicious content before proceeding with any actions with credentials. This may be used to protect the delegator's credentials against indirect phishing attacks, which may be done by leading the delegatee to a forged web service in hopes that the delegation service 334 may fill out a detected login screen without checking the forged web service's validity.

Referring now to FIG. 6, an exemplary delegation ticket 337 is illustrated, according to an embodiment. The delegation ticket 337 may be an access ticket for a specific user to act as another user. The delegation ticket 337 may include delegation elements. The delegation ticket 337 is used by the delegation service 334 to obtain distribute delegator credentials, define the scope of the delegation, and determine who is the delegatee. The delegation ticket 337 in FIG. 6 may include delegation elements as follow but is not limited to:
The web service 436 targeted (Web Mail)
The Delegator (Client A)
Login credentials (Username/Password)
The Delegatee(s) (Client B)
Duration of the delegation (24 hours)
Permissions (Write Mail, Read Mail)
Restrictions (View Archived, Write to Recipient A)
Tracking for delegation Activity (Yes)
Tracking for delegatees' usage (Yes)

The web service 436 is not a URL but may be taken from a list of known web-service information elements available to the delegation service 334. The login credentials may include the username and password as well as any two-factor authentication information. This may also include a connection to a token server or SMS capture service if such a setup is required to access the web service 436. The receiving delegatee or delegatees may be known to the delegation service 334 through the directory integration module 530 such as an LDAP. The duration of the delegation may define when the delegation automatically expires. Any active session may be forcibly terminated with the web client module 535 and delegatees may no longer authenticate using the delegation. Restrictions are action based and use the web application control module 520 of the delegation service 334. The restrictions allow the delegator to prevent the delegatee from executing the actions. It also allows the delegator to upload certain files or blockfiles containing specific patterns from being accessed/downloaded (e.g. anything with a specific “CONFIDENTIAL” header). The tracking may include a number of logging and monitoring options for example creating a full log of activities or reacting to specific actions or URLs accessed using the delegation. Reactions can be notification of security, dumping of session data, and display of notifications to the delegatee, for example.

Referring to FIG. 7, an example of an injection element 339 is illustrated, according to an embodiment. FIG. 7 illustrates a web service 436, which may include a web page 437. The web service 437 may be a web mail service for illustration purposes, which may include actions such as send, draft, archives, write email, and options displayed on the web page 437 of the web service 436. The interface injection module 515 may inject injection elements 339 onto the web page 437 when a user of the delegation service 334 is viewing the web service 436. FIG. 7 illustrates the injection element 339 to be a “Delegations” button. This may allow a delegator to create a delegation for the web service 436.

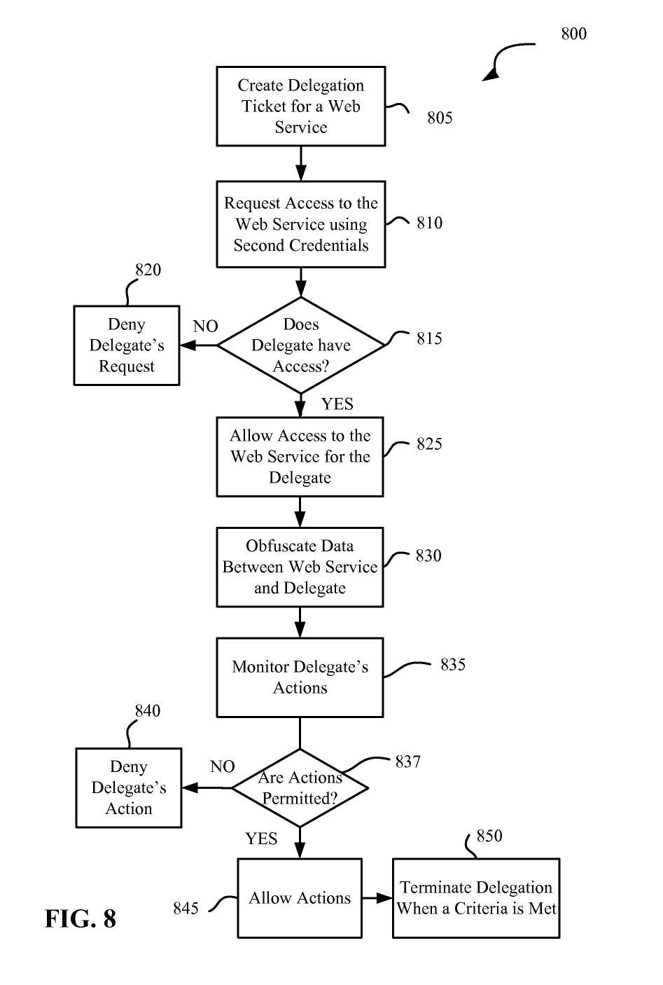

FIG. 8 illustrates an exemplary work flow of the delegation service 334, according to an embodiment. In operation 805, a delegation ticket 337 may be created. A delegator using a first client computer system 105A may want to delegate the delegator's authorization to use a web service 436 through a first credential of the delegator to another user (delegatee) that does not have authorization to use the web service 436. The delegator may access the web service 436 from the browser 235 on the first client computer system 105A through the delegation service 334 on a network node 110 over the communications network 120. The delegation service 334 may inject injection elements 339 onto the web page 437 of the web service 436 with the interface injection module 515 that the delegator may interact with to create a delegation ticket 337. The delegation ticket 337 may describe the scope of the delegation for the delegatee with the assistance of the web service information element module 510 and the web application control module 520 that may determine the feature and actions available of the web service 436. The delegatee may have access to the delegation service 334 through the second client computer system 105B with a second credential authorized to use the delegation service 337.

After the delegation ticket 337 is created, in operation 810, the delegatee may try to access the web service 436. To do this, the delegation service 334 may indicate to the delegatee that a delegation ticket 337 has been created for the delegatee. The delegatee, through the browser 235 of the second client 105B, may access the web service 436 through the delegation service 334. The delegation service 334 may inject a “Delegation” button on the web page 437 of the web service 436. In other embodiments, the delegatee may see a list of available delegations through the delegation configuration interface 338 of the web server 505. The delegatee may request access to the web service 436 with the button.

In operation 815, once the delegatee selects the “Delegation” button, the delegation service 334 may check the second credentials of the delegatee to the delegation ticket to determine if the delegatee has access. If the delegatee does not have access, the delegation service 334 may deny the delegatee's request for access to the web service 436, in operation 820. In operation 825, after it is determined there is a delegation created for the delegatee, the delegation service 334, using the web client module 535 and web service information element module 510 may log the delegatee onto the web service 436 using the first credentials of the delegator. In other embodiments, the delegation service 334 may automatically recognize the delegatee when the delegatee access the web service 436.

In operation 830, the data being transferred over the delegation session may be obfuscated by the session obfuscation module 525, which may use an encryption/decryption process. In operation 835, the delegation service 334 may also monitor the delegatee's actions, requests, and responses to requests to the web service 436. In operation 837, the delegation service 337 may determine whether the actions of the delegatee are restricted or permitted. If they are restricted, in operation 840, the delegation service may block them and perform any number of actions to alert the delegatee they are blocked, end the delegatee's session, alert the delegator, or alert IT personnel. In other embodiments, the interface injection module 515 may deactivate the actions in the HTML or JavaScript when compiled for the delegatee. If the delegatee's actions are not restricted, then, in operation 845, the action may be allowed. In operation 850, the delegation may end when a criteria is met such as when a time limit for the delegation has been reached, the delegator revokes the delegation, or the delegatee has abused the delegation.

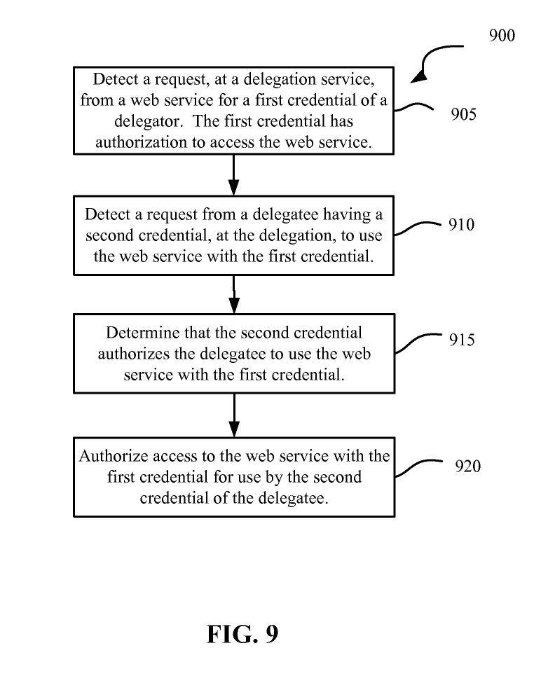

FIG. 9 illustrates a high level flow chart of a method 900 of performing a web service 436 delegation, according to an embodiment. In operation 905, the delegation service 334 may detect a request for a first credential of a delegator by a web service 436. The first credential has authorization to access the web service 436 for the delegator. In operation 910, the delegation service 334 may detect a request from a delegatee having a second credential to use the web service 436 with the first credential. In operation 915, the delegation service 334 may send the first credential to the web service 436 when determined that the second credential authorizes the delegatee to use the web service with the first credential. In operation 920, the delegation service 334 may authorize access to the web service with the first credential for use by the second credential of the delegatee.

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

Aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination thereof. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof. In the context of this disclosure, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination thereof.

Computer program code for carrying out operations for aspects of the present disclosure may be written in any combination of one or more programming languages, including: (a) an object oriented programming language; and (b) conventional procedural programming languages. The program code may execute as specifically described herein. In addition, the program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure have been described with reference to flowchart illustrations, block diagrams, or both, of methods, apparatuses (systems), and computer program products according to embodiments of this disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions or acts specified in the flowchart or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Although embodiments are described within the context of a stream computing application, this is not the only context relevant to the present disclosure. Instead, such a description is without limitation and is for illustrative purposes only. Additional embodiments may be configured to operate with any computer system or application capable of performing the functions described herein. For example, embodiments may be configured to operate in a clustered environment with a standard database processing application. A multi-nodal environment may operate in a manner that effectively processes a stream of tuples. For example, some embodiments may include a large database system, and a query of the database system may return results in a manner similar to a stream of data.

While the foregoing is directed to exemplary embodiments, other and further embodiments of the disclosure may be devised without departing from the basic scope thereof, and the scope thereof is determined by the claims that follow.

1-7. (canceled)

8. A computer system including a processor and a memory encoded with instructions, wherein the instructions when executed on the processor perform the following operations:
detecting a request, at a delegation service, from a web service for a first credential of a delegator, wherein the first credential has authorization to access the web service;
detecting a request from a delegatee having a second credential, at the delegation service, to use the web service with the first credential;
determining that the second credential authorizes the delegatee to use the web service with the first credential; and
authorizing access to the web service with the first credential for use by the second credential of the delegatee.

9. The computer system of claim 8, further comprising
detecting a first action of the web service.

10. The computer system of claim 9, further comprising:
restricting, by the delegator, the delegatee from performing the first action of the web service.

11. The computer system of claim 8, further comprising:
terminating the use of the web service by the second credential of the delegatee when a criteria is met.

12. The computer system of claim 8, further comprising:
obfuscating non-client data between the web service and the delegatee.

13. The computer system of claim 8, wherein the delegation service hides the first credential from the delegate and the delegation service is invisible to the web service.

14. The computer system of claim 8, wherein the delegation service may access the web service for the delegator and delegatee under the first credential concurrently.

15. A computer readable memory medium having instructions stored thereon which, when
executed, cause a processor to perform the following operations:
detecting a request, at a delegation service, from a web service for a first credential of a delegator, wherein the first credential has authorization to access the web service;
detecting a request from a delegatee having a second credential, at the delegation service, to use the web service with the first credential;
determining that the second credential authorizes the delegatee to use the web service with the first credential; and
authorizing access to the web service with the first credential for use by the second credential of the delegatee.

16. The computer readable memory medium of claim 15, further comprising detecting a first action of the web service.

17. The computer readable memory medium of claim 16, further comprising:
restricting, by the delegator, the delegatee from performing the first action of the web service.

18. The computer readable memory medium of claim 15, further comprising:
terminating the use of the web service by the second credential of the delegatee when a criteria is met.

19. The computer readable memory medium of claim 15, wherein the delegation service hides the first credential from the delegate and the delegation service is invisible to the web service.

20. The computer readable memory medium of claim 15, wherein the delegation service may access the web service for the delegator and delegatee under the first credential concurrently.
